(19) United States
(12) Patent Application Publication
(10) Pub. No.: US 2004/0013343 A1
(43) Pub. Date: Jan. 22, 2004

(54) Polarizer and optical device using it

(76) Inventors: Masaharu Hoshikawa, Tokyo (JP); Hiromitsu Umezawa, Tokyo (JP); Hiroshi Rikukawa, Tokyo (JP); Mikio Kitaoka, Tokyo (JP); Hideki Kawakami, Tokyo (JP); Shohei Abe, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/381,701

(22) PCT Filed: Sep. 26, 2001
(86) PCT No.: PCT/JP01/08329

(30) Foreign Application Priority Data
Oct. 4, 2000 (JP) 2000-304592

(51) Int. Cl. G02B 6/35; G02B 6/26; G02B 5/30

(52) U.S. Cl. 385/16; 385/140; 359/484

(57) ABSTRACT

Provided are an optical rotator which is capable of switch-operating at high speed, small in size and low in price, an optical switch readily compatible with an array structure and matrix form, and a variable optical attenuator readily compatible with an array structure. In the present invention, an optical rotator 14 comprises a lamination coil 10a, . . . , 10c having a through-hole and a Faraday element 11 arranged in the through-hole or a vicinity thereof, whereby a magnetic field caused by the coil is applied to the Faraday element. The Faraday element is arranged such that light passes vertically to the main surface thereof in which direction a magnetic field can be applied. A magnetism-holding member of a high magnetic permeable material is preferably arranged at least in a part of an outer periphery of the coil. In case the Faraday element uses a magnetic garnet crystal having a residual magnetization, obtained is an optical rotator having a self-sustaining function. Such an optical rotator is utilizable for an optical switch.

### TECHNICAL FIELD

The present invention relates to an optical rotator and optical device using same, and more specifically to an optical rotator arranging a Faraday element arranged in a through-hole or its vicinity of a coil having through-hole to thereby eliminate the necessity of a yoke and achieve size reduction and characteristics improvement, and to an optical device, such as an optical switch or an optical attenuator, using the same.

### BACKGROUND OF THE INVENTION

The optical rotator is a device for rotation-controlling the angle of a polarization plane of input light, which is used for an optical switch, an optical attenuator, a polarization scrambler or the like. The conventional optical rotator is structured by a Faraday element and an electromagnet for applying a magnetic field to the Faraday element. The electromagnet is in a structure having a coil wound around a partially-open annular yoke (C-form). A Faraday element of a magneto-optical crystal is inserted in the partially-open part of the yoke, providing a structure that a magnetic field caused due to the coil can be guided by the yoke and applied to the Faraday element.

In the case of an optical rotator having such a self-sustaining function that the angle of a polarization plane of input light does not return even when an excitation current to the coil is put off, the yoke uses a semi-hard magnetic material and the Faraday element uses a soft-magnetic magneto-optical crystal. Accordingly, in this case, the self-sustaining function of the optical rotator is by virtue of the property of the semi-hard magnetic material as a yoke.

Also, there is a variable optical rotator as an optical rotator capable of rotation-controlling a polarization plane of input light to an arbitrary angle. This is structured with a Faraday element, an electromagnet for applying a variable magnetic field to the Faraday element, and a permanent magnet for applying a fixed magnetic field. Also in this case, the electromagnet is in a structure that a coil is wound around a partially-open annular yoke (C-form). A Faraday element of a magneto-optical crystal is inserted in the partially-open part of the yoke, providing a structure that a magnetic field caused due to the coil can be guided by the yoke and added by a fixed magnetic field due to the permanent magnet to apply the resultant magnetic field thereof to the Faraday element.

The optical rotator in the conventional structure like the above, because of using an electromagnet structured by winding a wire over the yoke, is large in size and expensive, furthermore requiring a long time in switching the applied magnetic field direction (typically, approximately 300 μsec.). Because the switching time is determined depending upon a yoke material property, high-speed switching is difficult. Also, because of necessity of a large-sized yoke as noted above, it is not suited for integration. Since the optical rotator is large-sized and expensive, the optical device in various kinds using the same is naturally large-sized and expensive.

### SUMMARY OF THE INVENTION

An object of the present invention is to provide an optical rotator which is capable of switch-operating at high speed, small in size and low in price.

Another object of the invention is to provide an optical switch which is capable of switching at high speed, small in size and low in price, and readily compatible with array structure or matrix form.

Still another object of the invention is to provide a variable optical rotator which is small in size and low in price.

Yet another object of the invention is to provide a variable optical attenuator which is small in size and low in price and readily compatible with array structure.

The present invention is an optical rotator comprising: a coil having a through-hole and a Faraday element arranged in the trough-hole or a vicinity thereof, whereby a magnetic field caused by the coil is applied to the Faraday element. The Faraday element is arranged such that light passes vertically to the main surface thereof in which direction a magnetic field can be applied.

Herein, the coil is preferably a lamination coil having electric insulation layers and conductor patterns alternately layered, the conductor patterns at ends being connected one with another thereby being superposed in a layering direction within an electric insulators in a rectangular frame form. Also, a magnetism-holding member of a high magnetic permeable material is preferably arranged at least in a part of an outer periphery of the coil. In case the Faraday element uses a magnetic garnet crystal having a residual magnetization, obtained is an optical rotator having a self-sustaining function (function of keeping a Faraday rotation angle even if a coil excitation current is put off). In some applications, the Faraday element incorporates a soft magnetic garnet crystal not having residual magnetization.

Also, the invention provides an optical rotator array comprising: a lamination coil having a plurality of through-holes and coil parts respectively formed around the through-holes; Faraday elements arranged in the through-holes or a vicinity thereof; and a magnetism-holding member of a high magnetic permeable material arranged at least on a part of an outer periphery of the lamination coil; whereby a magnetic field caused by the coil part is applied to the corresponding Faraday element.

Furthermore, the invention is an optical switch having a combination of an optical rotator, an optical reciprocal rotator, and polarization separating/combining elements respectively arranged on an optical path in front or back thereof, whereby an optical path is switched by switching a coil excitation current. For example, there is a structure having the optical rotator, a ½-wavelength plate, and polarizing beam splitters respectively arranged on an optical path in front or back thereof, or a structure having the optical rotator, a ½-wavelength plate, and birefringent elements respectively arranged on an optical path in front or back thereof.

By arranging a plurality of the above optical switches side by side in a two-dimensional or three-dimensional fashion, an optical switch array can be structured. By multi-stage connection in a lattice form, a matrix optical switch can be structured.

Meanwhile, the invention is a variable optical rotator comprising: a coil having a through-hole; a Faraday element arranged in the trough-hole or a vicinity thereof; and a permanent magnet arranged close to an outer periphery of the Faraday element, whereby a resultant magnetic field of a variable magnetic field caused by the coil and a fixed magnetic field due to the permanent magnet is applied to the Faraday element. Of course, the variable magnetic field and the fixed magnetic field are in a relationship acting in different directions. The coil is preferably a lamination coil as noted before. Meanwhile, a magnetism holding member of a high magnetic permeable material is preferably arranged at least in a part of an outer periphery of the coil. The Faraday element is preferably formed of a soft magnetic garnet crystal not having a residual magnetization so that magnetization is saturated by a fixed magnetic field due to the permanent magnet.

The invention is a variable optical attenuator having a variable optical rotator and polarizing elements arranged on an optical path in front and back thereof. By arranging a plurality of such optical attenuators side by side, a variable optical attenuator array can be structured.

### BRIEF DESCRIPTION OF THE DRAWINGS

FIG. 1 is an exploded perspective view showing one embodiment of an optical rotator according to the present invention.

FIG. 2 is an assembly perspective view of the optical rotator shown in FIG. 1.

FIGS. 3A and 3B are sectional explanatory views at an x-x position in FIG. 2.

FIG. 4 is an explanatory view showing a characteristic example of a Faraday element.

FIG. 5 is an explanatory view showing one example of an optical switch unit.

FIG. 6 is an explanatory view showing one example of a matrix optical switch to which the optical switch unit of FIG. 5 is applied.

FIG. 7 is an explanatory view showing one example of an optical switch.

FIGS. 8A and 8B are operation explanatory views of the optical switch shown in FIG. 7.

FIGS. 9A and 9B are explanatory views of the ½-wavelength plate and Faraday rotator of FIG. 7.

FIG. 10 is an explanatory view showing one example of an optical rotator array.

FIG. 11 is an explanatory view showing one example of an optical switch array.

FIGS. 12A and 12B are explanatory views showing one example of a variable optical rotator.

FIG. 13 is an explanatory view showing a characteristic example of a Faraday element of the variable optical rotator shown in FIG. 12.

FIG. 14 is an explanatory view showing one example of a variable optical attenuator.

FIG. 15 is an explanatory view showing another example of a variable optical attenuator.

### BEST MODE FOR CARRYING OUT THE INVENTION

An optical rotator according to the present invention, in one of the optimal structures, accommodates a Faraday element using a magnetic garnet crystal having residual magnetization within a through-hole of a lamination coil in a rectangular frame form, and arranging a magnetism-holding member of a high magnetic permeable material in part of an outer periphery of the lamination coil, whereby a magnetic field caused by the lamination coil can be applied to the Faraday element. The Faraday element is incorporated parallel, at its main surface, with the lamination coil so that light is to be passed vertical to the main surface. By incorporating it within the through-hole, it is possible to increase an applied magnetic field and further reduce the size.

The combination of a lamination coil and a Faraday element is arbitrary, i.e. the structure may be that of accommodating a Faraday element in a through-hole of one lamination coil, or the structure may be that of superposing a plurality of lamination coils and accommodate a Faraday element in a communicated through-hole thereof. By supplying an excitation current to the coil, a magnetic field is applied to the Faraday element to rotate a polarization plane of the input light to the Faraday element. In case the Faraday element uses a material that magnetization saturates under a small magnetic field and having a residual magnetization, obtained is an optical rotator that the Faraday rotation angle saturates under a small magnetic field induced by the coil. By inverting the direction of an excitation current to the coil, the magnetic field applied to the Faraday element can be inverted in direction. This makes it possible to obtain an optical rotator that the Faraday rotation angle is variable, for example, by ±45 degrees.

The lamination coil is inexpensive because it can be simultaneously fabricated in multiplicity. The use of same can reduce the cost for the optical rotator. The applied magnetic field is small only with the lamination coil having through-hole. By arranging a magnetism-holding member of a high magnetic permeable material on a coil outer periphery, the magnetic field caused by the coil does not spread to the outside, making it possible to increase the applied magnetic field onto the Faraday element. In case of arranging a magnetic material having a magnetic permeability, for example, of nearly 1000, the magnetic field to be applied is 1.5 times in intensity. The magnetism-holding member desirably in a structure using a channel member sectionally in a squared-U form, for example, to fit a groove part thereof in a lateral part of the coil.

The coil may be in a structure using a cement wire wound and cured or in a structure a wire is wound and molded with a resin or the like, besides a lamination coil like the above.

A variable optical rotator according to the invention, in one of the optimal structures, accommodates a Faraday element using a soft magnetic garnet crystal with no residual magnetization in a through-hole of a lamination coil in a rectangular frame form, and arranging a magnetism-holding member of a high magnetic permeable material and a permanent magnet in part of an outer periphery of the lamination coil, whereby a variable magnetic field caused by the lamination coil and a fixed magnetic field by the permanent magnet can be applied to the Faraday element.

When the coil is not passed by an excitation current, the Faraday element is in saturation in a surface direction by a magnetic field due to the permanent magnet arranged for magnetization vertically to a propagation direction of light. By allowing an excitation current to flow to the coil, a magnetic field is caused relying upon a magnitude of the current in a propagation direction of light (vertical to the main surface of the Faraday element). Because the Faraday element is magnetized in a direction of the resultant magnetic field of these two external magnetic fields and always in a magnitude for saturation, the Faraday rotation angle relies upon a component in light propagation direction of an intensity of magnetization on the Faraday element. Namely, because the Faraday rotation angle varies with the magnitude of an excitation current flowing to the coil, obtained is an optical rotator that the polarization plane is variable. Herein, the reason of changing the Faraday rotation angle always in a saturation state is that keeping saturation makes it possible to suppress magnetic domains from occurring and insertion loss low.

Hereunder, explanation will be made on a preferred embodiment of the present invention shown in the drawings.

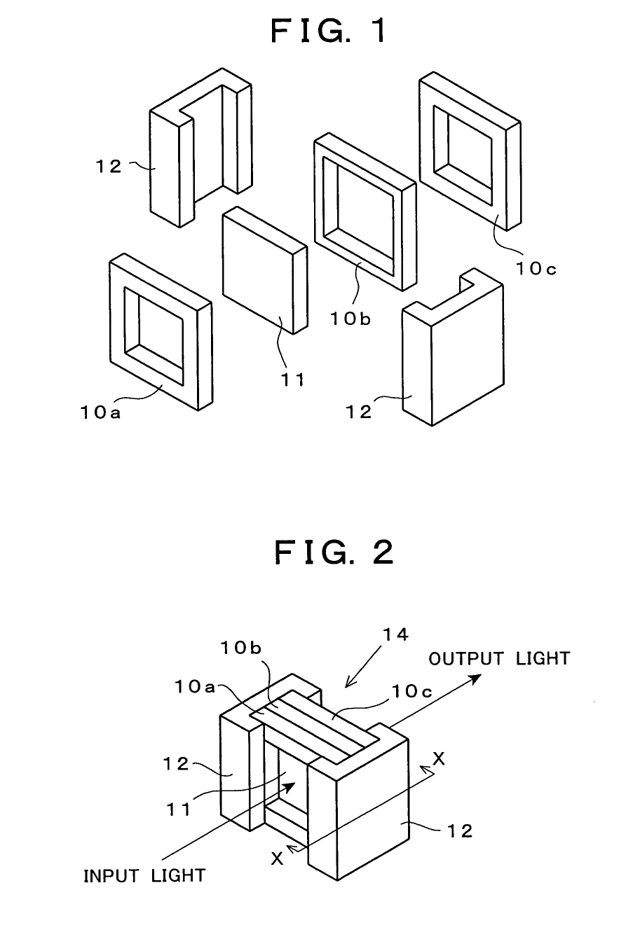

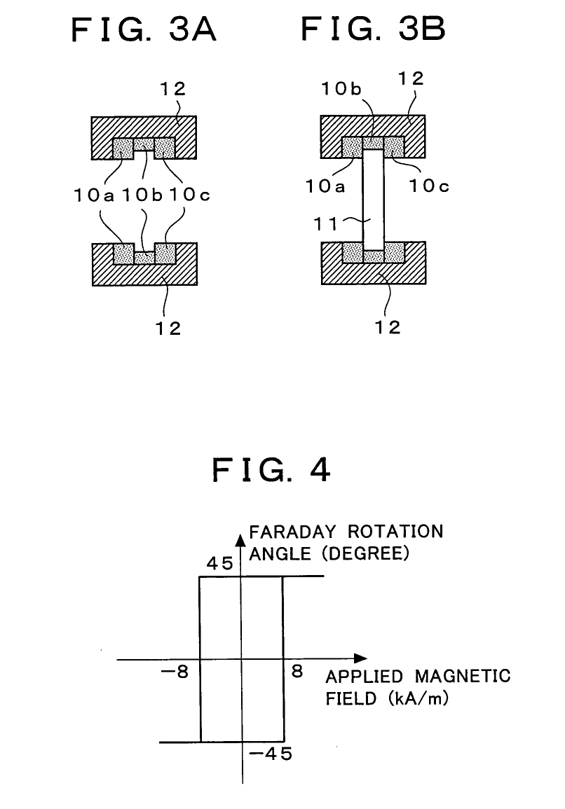

FIG. 1 is an exploded perspective view showing one embodiment of an optical rotator according to the invention, while FIG. 2 is an assembly perspective view. FIGS. 3A and 3B show sectional views in its x-x position. FIG. 3A represents only magnetic-field applying means, while FIG. 3B a shape of the optical rotator overall.

Three lamination coils 10a, 10b, 10c, having a rectangular frame form, are superposed to communicate at their central through-holes and connected in series at their coil parts, whereby a Faraday element 11 is accommodated within the through-hole. Herein, each lamination coil 10a, . . . , 10c has a structure having alternately-laminated electric insulation layers and conductor patterns, wherein the conductor patterns at their ends are connected one with another thereby being superposed in a lamination direction within the rectangular-frame-formed electric insulator. The three lamination coils 10a, . . . , 10c are equal in outer size. The size of through-hole is equal between the outer lamination coils 10a, 10c but the intermediate lamination coil 10b is designed somewhat greater than those. The Faraday element 11 is accommodated in the somewhat greater through-hole of the intermediate lamination coil 10b, and clamped by the outer lamination coils 10a, 10c. Namely, these lamination coils serves also as a Faraday element holder.

Furthermore, magnetism-holding members 12, of a high magnetic permeable material, are arranged on outer peripheries of the coupled coil structure thus combined. The magnetism-holding members 12 are channel members sectionally in a squared-U form, in grooves of which are fitted the outer peripheries of the coil structure. In this embodiment, two magnetism-holding members 12 are oppositely arranged.

Using an Ag, Ag—Pd, Ag—Cu based material for the internal conductor and an Ni—Zn based ferrite for the insulation layer, combination was made between two outer lamination coils 10a, 10c having totally 80 turns by layering, by 20 layers, conductor patterns having 4 turns per layer and one intermediate lamination coil 10b having totally 40 turns by laminating, by 20 layers, conductor patterns having 2 turns per layer. The outer lamination coil has an outer size of 3 by 3 mm and a through-hole size of 2.25 by 2.25 mm, while the intermediate lamination coil has an outer size of similarly 3 by 3 mm and a through-hole size of 2.5 by 2.5 mm. By combining these three coils, totally 200 turns were provided. The methods for forming the lamination member roughly include a method that ceramics is formed into a sheet form and a conductor pattern is screen-printed thereon, which ceramics sheets are laminated and press-bonded together (sheet lamination method) and a method that ceramics patterns and conductor patterns are alternately screen-printed thereby being laminated (print-lamination method), any of which is applicable. After lamination, sintering is done. The magnetism-holding member 12 uses an Mn—Zn based soft ferrite. This can apply a magnetic field of 12 kA/m or greater to the through-hole center by an excitation current of 0.1 A.

The Faraday element 11 used a (GdBi)₃(FeAlGa)₅O₁₂ crystal, which was combined with the foregoing lamination coils 10a, . . . , 10c. The Faraday element 11 exhibits a characteristic of Faraday rotation angle—applied magnetic field as shown in FIG. 4. The angle of Faraday rotation saturates (±45 degrees) at an applied magnetic field of 8 kA/m, and thereafter the angle of Faraday rotation is kept in a saturated state (having a residual magnetism) even if the applied magnetic field is reduced to zero.

On the optical rotator 14, the applied magnetic field is changed in direction by switching the direction of an excitation current (pulse) supplied to the lamination coil. Depending upon the characteristic of the Faraday element to be applied by a magnetic field, it is possible to invert the sign of a rotation angle of a polarization plane of passing light. The switching is at a speed of 20 μsec. or less.

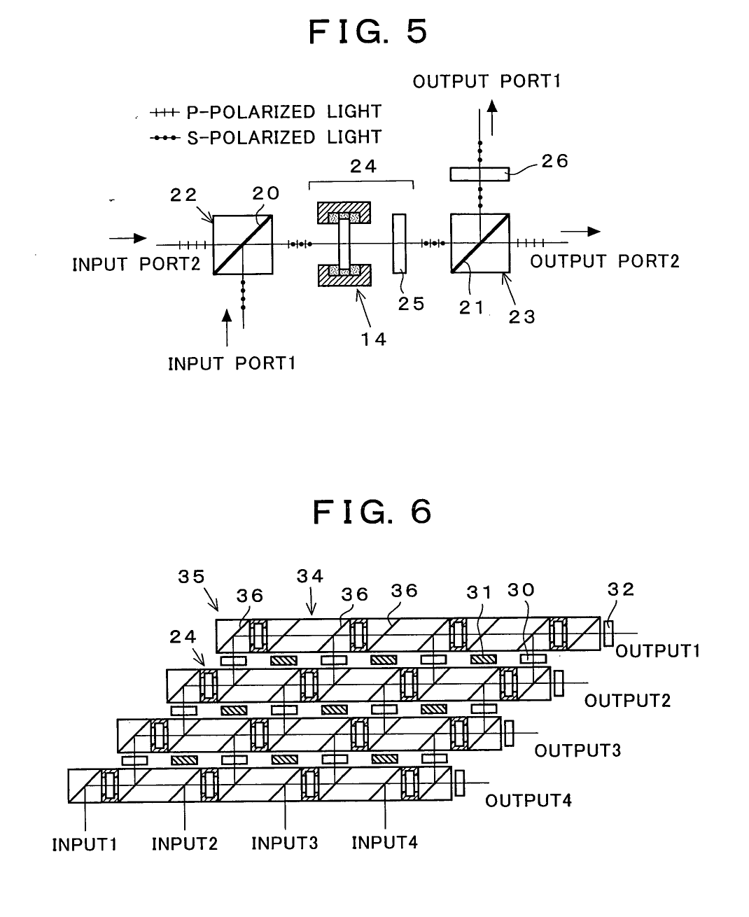

FIG. 5 is an explanatory view showing an example of an optical switch unit according to the invention. The optical switch unit has a pair of polarizing beam splitters 22, 23 arranged parallel in polarization separator film 20, 21, a variable polarization rotating section 24 (optical rotator 14 and ½-wavelength plate 25) arranged between the both polarizing beam splitters, and a polarizer 26 for absorbing P-polarized light. The polarizing beam splitter 22, 23 is in such a hexahedron form that pillar-like members sectionally in a rectangular isosceles triangle are bonded together through a sandwiched polarization separator film 20, 21. The polarization separator films 20, 21, the optical rotator 14 and the ½-wave plate 25 are arranged on one line. An input port 1 and an input port 2 are positioned oppositely to two adjacent surfaces of one polarizing beam splitter 22, while an output port 1 and an output port 2 are positioned oppositely to two adjacent surfaces of the other polarizing beam splitter 23. The optical rotator 14, structured as per the foregoing, is adjusted for switching ±45 degrees for a wavelength 1550 nm of light. Because the ½-wavelength plate 25 has a function to symmetrically rotate a polarization plane of input light about its optical axis, the optical axis herein is set in such a direction as to rotate a polarization plane of incident light by just 45 degrees.

The direction of polarization-plane rotation of light due to the optical rotator 14 is determined by a direction of applied magnetic field due to the coil, whereas the direction of polarization-plane rotation of light due to the ½-wavelength plate 25 is a constant direction. Consequently, on the variable polarization rotating section 24 combined with them, depending on a direction of excitation current to the coil, the polarization-plane rotation direction of light is not totally rotated or rotated by 90 degrees or there is exchange or no exchange between P-polarized light and S-polarized light.

By a direction of excitation current to the coil, the rotation angle of a polarization plane in the variable polarization rotating section 24 is set at 0 degree. The S-polarized light, having entered at the input port 1, reflects upon the polarization separator film 20 to direct toward the variable polarization rotating section 24 where it undergoes 0 degree of polarization-plane rotation (i.e. no polarization-plane rotation) remaining in S-polarization light. This reflects upon the polarization separator film 21 and exits to the output port 1. The P-polarized light, having entered at the input port 2, transmits through the polarization separator film 20 and travels toward the variable polarization rotating section 24 where it undergoes 0 degree of polarization-plane rotation (i.e. no polarization-plane rotation) remaining in P-polarized light. This transmits through the polarization separator film 21 and exits to the output port 2.

The direction of excitation current is reversed to the coil to invert the direction of applied magnetic field to the Faraday element, thereby switching the rotation angle of polarization plane to 90 degrees in the variable polarization rotating section 24. The S-polarized light, entered at the input port 1, reflects upon the polarization separator film 20 to direct toward the variable polarization rotating section 24 where it undergoes 90 degree of polarization rotation and turns into a P-polarized light. This transmits through the polarization separator film 21 and exits to the output port 2. The P-polarized light, having entered at the input port 2, transmits through the polarization separator film 20 and directs toward the variable polarization rotating section 24 where it undergoes 90 degree of polarization-plane rotation and turns into an S-polarized light. This reflects upon the polarization separator film 21 and exits to the output port 1.

Accordingly, the optical switch unit can switch, by switching operation of a 0.1-A excitation pulse current to the coil, between a bar state of input port 1→output port 1 and input port 2→output port 2 and a cross state of input port 1→output port 2 and input port 2→output port 1. This singly operates as a 2×2-type optical switch. Its switching speed is 20 μsec. or less, insertion loss is 0.2 dB or lower, and crosstalk at output port 2 is −30 db or less. Furthermore, by the arrangement of a polarizer 26 for absorbing p-polarized light at the output port 1, the crosstalk is −40 dB or lower at the output port 1. Also, this structure is a basic unit suited for stage increase, because of coincidence between geometrical propagation direction and propagating polarized-light state in the input/output. Incidentally, concerning the output port 2, in the case that the optical switch unit is made multi-staged, a parallel-nicol state, or two-stage state, is provided by the first polarizing beam splitter in the succeeding unit thus obtaining a crosstalk of −50 dB or lower.

For structuring an optical switch by using the optical switch unit, though not especially shown, polarization control sections may be arranged on the ports which comprise optical-path separating/combining birefringent elements and ½-wavelength plates inserted into either path. The polarization control section serves for the function to change a random polarized light into a P-polarized light or S-polarized light or returning the P-polarized light or S-polarized light to a random polarized light, thus obtaining an optical switch having random polarized light as input/output.

FIG. 6 is an explanatory view showing one example of a matrix optical switch according to the invention. In principle, optical switch units as shown in FIG. 5 are arranged in matrix (lattice form) of M×N in the number (where, any one of M and N is an integer of 1 or greater while the other is an integer of 2 or greater: herein, M=N=4) to provide polarizing elements 30 and optical absorber 31 between the optical switch units, wherein input ports in the number of M and output ports in the number of N are structurally arranged respectively along the two adjacent sides of the matrix. Also, polarizing elements 32 are arranged also on the ports at the output side.

In fabricating a matrix optical switch, two kinds of polarizing beam splitter 34, 35 are preferably used. The first polarizing beam splitter 34 is structured entirely in a cuboid by bonding pillar-like members sectionally in a rectangular isosceles triangle onto both ends of a pillar-like member having a sectional form of parallelelogram through polarization separator films 36. The second polarizing beam splitter 35 is structured entirely in a cube by bonding pillar-like members sectionally in a rectangular isosceles triangle through a polarization separator films 36. Arrangement is made by interposing variable polarization rotating sections 24 such that the second polarizing beam splitters 35 are positioned at both ends. Incidentally, the variable polarization rotating section 24 is a combination of a ±45-degree variable optical rotator 14 and a ½-wavelength plate 25, as shown in FIG. 5. These are arranged with a constant spacing, to arrange the polarizing elements 30 and optical absorbers between them.

By the structure like this, obtained is a 4×4-type matrix optical switch. The input light from the input port 1 is coupled to any of the output port 1-output port 4 depending upon a polarization-plane rotation angle by the variable polarization rotating section 24. This is true for the input port 2-input port 4. Switching speed is 20 μsec. or less, insertion loss is 8 dB or low, and crosstalk is −45 dB.

In fabricating a multistage-structured matrix optical switch, in case the leak light released outside of a certain optical switch unit leaks into another optical switch unit, the matrix optical switch in its entire becomes deficient in shielding characteristic. In the present embodiment, because the leak light having released outside a certain optical switch unit is absorbed by the optical absorber, it is possible to prevent it from leaking into another optical switch unit. Because the optical rotator does not use a yoke as in the conventional, there is no projection in a direction vertical to the page of FIG. 6. Accordingly, the two-dimensional matrix as shown can be piled up in the vertical direction to the page and extended in a three-dimensional fashion. By piling up four sets for example, obtained is a (4×4)×4 matrix optical switch array.

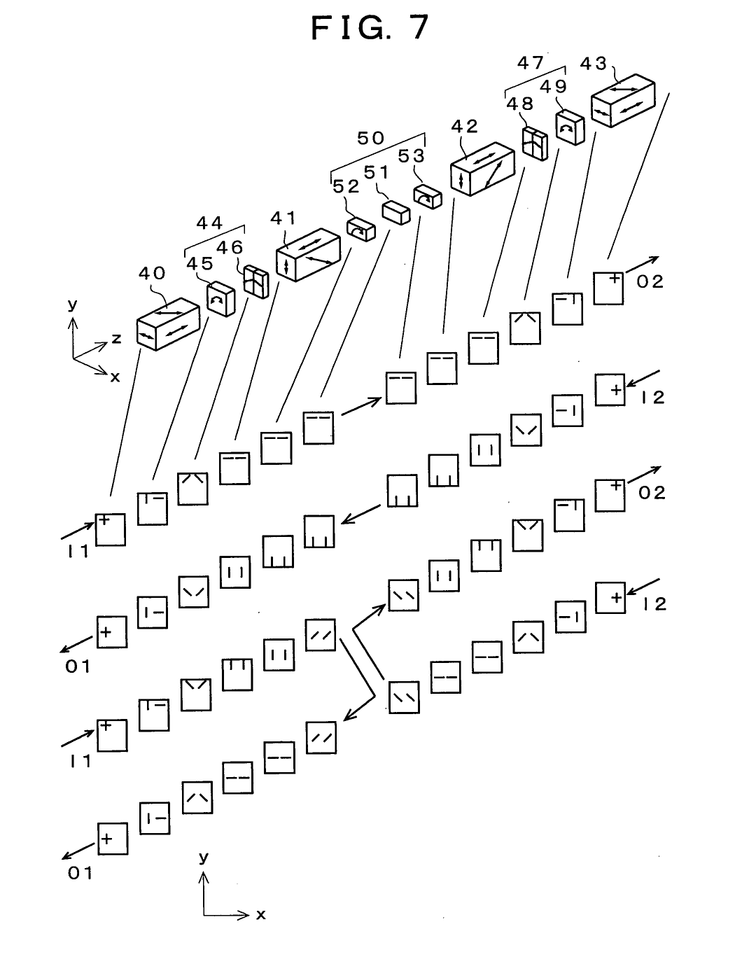

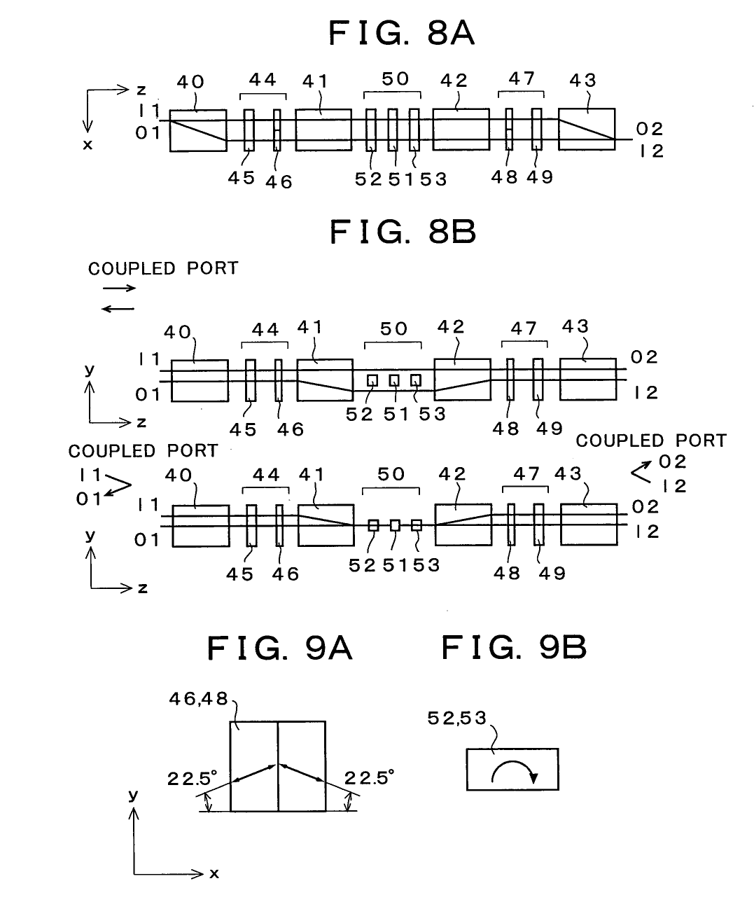

FIG. 7 is an explanatory view showing another embodiment of an optical switch according to the invention, while FIG. 8 is an optical path explanatory view on the same wherein the optical switch is 2×2 type. FIG. 7 shows an arrangement state of the optical parts and a polarization state between the optical parts. Incidentally, the arrow in the optical part shows an optical-axis direction or a Faraday-rotation direction. Meanwhile, the following coordinate axes are set up in order for easier understanding. It is assumed that the arrangement direction of the optical parts is z-direction (depthwise direction in the figure) and the two directions orthogonal thereto are x-direction (horizontal direction in the figure) and y-direction (vertical direction in the figure). Also, concerning rotating direction, the clockwise as viewing in a z-direction is assumably taken as a plus side.

A first separating/combining birefringent element 40 which separates light of a same path, the polarization direction of which is in an orthogonal relation, in a x-direction and combines light of a different path in a x-direction, a first optical-path controlling birefringent element 41 in which a normal light travels straight according to a polarization direction while an abnormal light shifts the optical path in a −y-direction, a second optical-path controlling birefringent element 42 in which a normal light travels straight according to a polarization direction while an abnormal light shifts the optical path in a +y-direction, and a second separating/combining birefringent element 43 which separates light of a same path, the polarization direction of which is in an orthogonal relation, in a x-direction and combines light of a different path in a x-direction, are arranged spatially in this order in a z-direction.

Between a first separating/combining birefringent element 40 and a first optical-path controlling birefringent element 41 as viewed in the z-direction, arranged is first polarization rotating means 44 for changing polarization direction from an orthogonal to a parallel (from a parallel to an orthogonal, in the reverse direction). The first polarization rotating means 44 comprises a combination of a ±45-degree variable optical rotator 45, a set of two ½-wavelength plates 46 arranged side by side to have optical axes in symmetry on the left/right both optical paths. Similarly, between a second optical-path controlling birefringent element 42 and a second separating/combining birefringent element 43, arranged is second polarization rotation changing means 47 for changing polarization direction from a parallel to an orthogonal (from an orthogonal to a parallel, in the reverse direction). The second polarization rotation changing means 47 also comprises a combination of a set of two ½-wavelength plates 48 arranged side by side to have optical axes in symmetry on the both left/right optical paths and a ±45-degree variable optical rotator 49. Incidentally, the two optical rotators 45, 49 are in the same structure as those shown in FIG. 2, which switches the direction of excitation current to the coil to thereby control a direction of applied magnetic field, thus switching the Faraday rotation angle to +45 degrees or −45 degrees. Herein the structure is to switch together the both optical rotators 45, 49 such that they have the same Faraday rotation direction. Also, the two ½-wavelength plates 46, 48, as shown in FIG. 9A, has a left optical path having an optical axis inclining −22.5 degrees with respect to the x-direction and a right optical path having an optical axis inclining 22.5 degrees with respect to the x-direction, which are integrated into symmetry about the y-axis.

Furthermore, viewing in the z-direction, between the first optical-path controlling birefringent element 41 and the second optical-path controlling birefringent element 42, arranged is polarization reflection control means 50 having a both-sided mirror for reflecting the light on part of optical paths, for causing a bypass light to keep the polarization direction but a reflection light to rotate 90 degrees in polarization direction. Herein, the polarization reflection control means 50 comprises a both-sided mirror 51 for reflecting a light on part of optical paths, and 45-degree Faraday rotators 52, 53 arranged in the forward and backward thereof. The both 45-degree Faraday rotators 52, 53 are set up only on a middle-staged optical path (central optical path with respect to y-direction), similarly to the both-sided mirror 51 in the z-direction. Accordingly, the middle-staged optical path is resultingly completely put off by the both-sided mirror 51. Incidentally, the both Faraday rotators 52, 53 rotate +45 degrees a polarization plane due to a magnetic field in a constant direction applied by a permanent magnet.

Viewing in the z-direction, on a side of the first separating/combining birefringent element 40, a first input port I1 in the upper stage and a first output port O1 in the middle stage are set with a deviation in the y-direction while, on a side of the second separating/combining birefringent element 43, a second input port I2 in the middle stage and a second output port O2 in the upper stage are set with a deviation in the y-direction.

Although detailed operational explanation is omitted, in case an applied magnetic field is first set for the optical rotator 45, 49 to have a plus direction of Faraday rotation direction (see the upper figure in FIG. 8B), the light inputted in the z-direction at the first input port I1 in upper stage is outputted from the second output port O2 in the upper stage. The light inputted in the −z-direction at the second input port I2 in middle stage is outputted from the first output port O1 in middle stage. Next, in case an applied magnetic field is set for the optical rotator 45, 49 to have a minus direction of Faraday rotation direction (see the lower figure in FIG. 8B), the light inputted in the z-direction at the first input port I1 in upper stage is outputted from the first output port O1 in middle stage. The light inputted in the −z-direction at the second input port I2 in middle stage is outputted from the second output port O2 in upper stage. In this manner, a 2×2 type optical switch is realized. Because the optical path in middle stage is completely put off in the z-direction by the both-sided mirror, there is no region where optical paths are overlapped, resulting in no leak of light. The switch like this, wherein the members are in a linear arrangement and every one of light inputs and outputs in parallel with the optical path, is suited for structuring an optical switch array by an arrangement side by side.

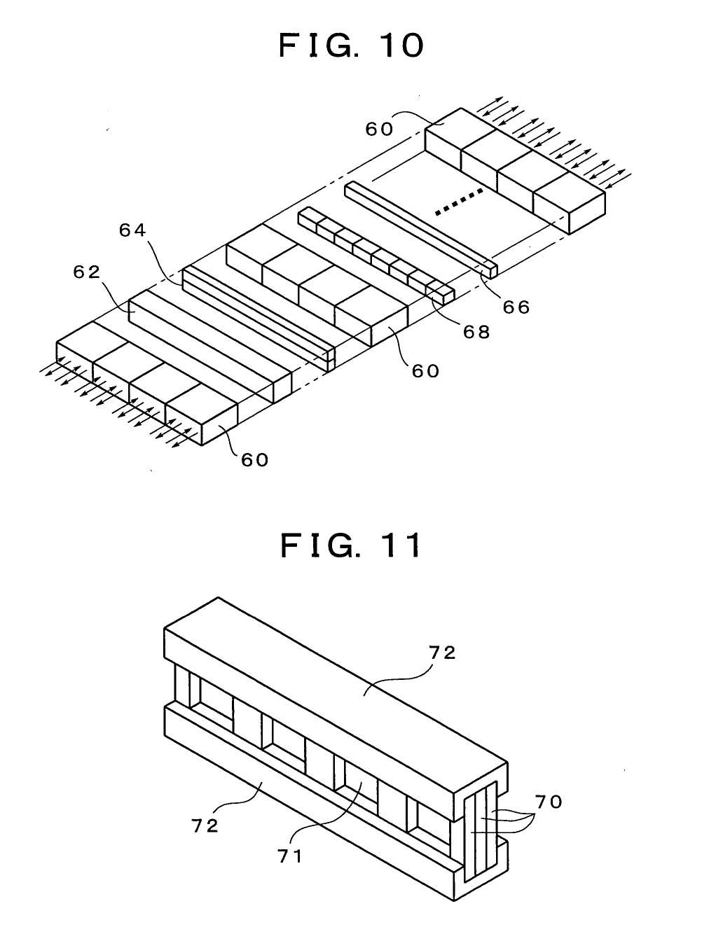

FIG. 10 is an explanatory view of such an optical switch array. This is basically in a structure that the optical switch of FIG. 7 is arranged eight side by side. Separating/combining birefringent elements 60 are in a structure that those for two units are integrated into one, while optical rotators 62, ½-wavelength plates 64 and mirrors 66 are in a structure that those for eight rows are integrated into one. Faraday rotators 68 are arranged eight side by side. Incidentally, in order to simplify the figure, FIG. 10 omittedly shows the optical switch array in nearly a half thereof. Although this structure is in a two-dimensional arrangement, these, if necessary, can be piled up to provide a three-dimensional arrangement.

There is shown in FIG. 11 an example of an optical rotator array used in the optical switch array. Fabricated is a lamination coil 70 having a plurality of rectangular through-holes (four in this example) and coil parts formed around the respective through-holes. Three lamination coils 70 are superposed to communicate in the through-holes, and the corresponding coil parts around the same through-hole are connected in series. Faraday elements 71 are accommodated in each through-hole of the intermediate lamination coils, and clamped and held by the outer lamination coils. Magnetism-holding members 72 of a high magnetic permeable material are arranged on longer sides of the coil structure thus combined. The magnetism-holding member 72 is a channel member sectionally in a squared-U form, in a groove of which an outer periphery of the coil structure is fitted. Herein, two magnetism-holding members 72 are oppositely arranged. This can reduce the spacing between the adjacent Faraday elements 71 and the number of parts.

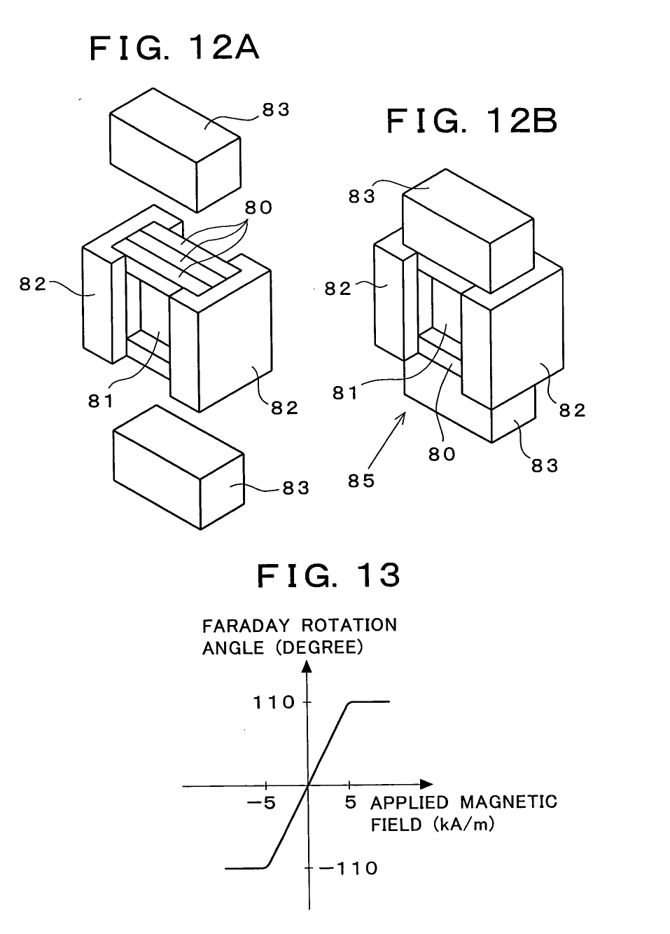

FIGS. 12A and 12B are explanatory views showing one embodiment of a variable optical rotator according to the invention. Within a through-hole of a lamination coil 80 in a rectangular frame form, accommodated is a Faraday element 81 of soft magnetic garnet having no residual magnetization. On part of outer periphery of the lamination coil 80, arranged are magnetism-holding members 82 of a high magnetic permeable material, and further permanent magnets 83 are arranged. The structure of the lamination coil 80 and magnetism-holding member 82 may be similar to the optical rotator stated related to the foregoing FIGS. 1 and 2.

The internal conductor used Ag, Ag—Pd or Ag—Cu based material while the insulating layer used an Ni—Zn based ferrite, to combine two outer lamination coils having totally 120 turns due to laminating 30 layers of conductor patterns having 4 turns per layer and one intermediate lamination coil having totally 60 turns due to laminating 30 layers of conductor patterns having 2 turns per layer. The outer lamination coils have an outer size of 3×3 mm and a through-hole size of 2.25×2.25 mm while the intermediate lamination coil has the same outer size of 3×3 mm and a through-hole size of 2.5×2.5 mm. By combining these three lamination coils, total 300 turns were provided. The magnetism-holding member used Mn—Zn based soft ferrite. This enabled to apply a magnetic field of 16 kA/m or greater to the through-hole center by an excitation current of 0.1 A.

The Faraday element used a (GdBi)₃(FeAlGa) 5O₁₂ crystal, which was combined with the foregoing lamination coils. The magnetic garnet crystal, due to a thermal process in the air at 1100° C. for 8 hours, exhibits soft magnetism without having a residual magnetism. The Faraday rotation angle—applied magnetic field characteristic of this Faraday element is shown in FIG. 13. The Faraday rotation angle saturates at an applied magnetic field of 5 kA/m (110 degrees). Under the applied magnetic field equal to or lower than that, the Faraday rotation angle varies in proportion to an intensity of applied magnetic field. A permanent magnet was set up such that the Faraday element is saturated with magnetism only by the fixed magnetic field thereof. In this manner, the variable magnetic field caused by the lamination coil is applied vertically to the main surface of the Faraday element (in light propagation direction) while the fixed magnetic field by the permanent magnet is in a direction of the main surface of the Faraday element (in a direction vertical to the light propagation direction). By controlling a current of the excitation current supplied to the lamination coil between 0A and 0.1A, the Faraday rotation angle can be varied within a range of 80 degrees or greater.

When an excitation current is not flowed to the coil, the Faraday element is magnetically saturated in a direction of main surface by a magnetic field due to the permanent magnet. By flowing an excitation current to the coil, a magnetic field is caused depending upon a magnitude of the current. Because the Faraday element is magnetized in the resultant direction of the two external magnetic fields and always in a magnitude for saturation, the Faraday rotation angle relies upon a light propagation direction component of magnetization intensity to the Faraday element. Namely, because the Faraday rotation angle varies with the magnitude of an excitation current flowing to the coil, obtained is an optical rotator in which the polarization plane is variable. Herein, the reason that the Faraday rotation angle is changed always in a saturated state is that keeping saturation can suppress against occurrence of magnetic domains and insertion loss can be suppressed low.

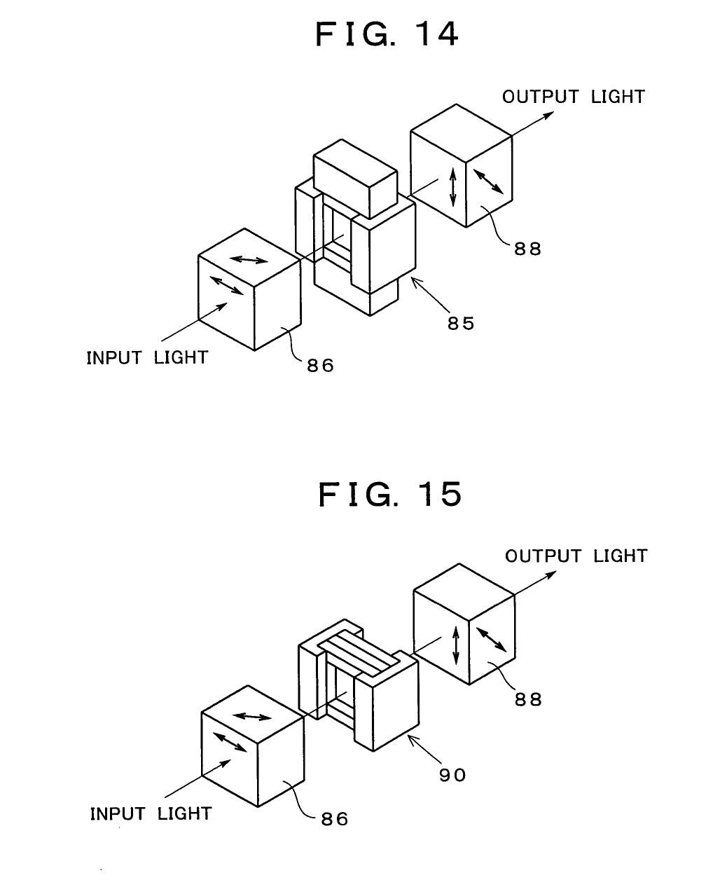

FIG. 14 is an explanatory view showing an example of variable optical attenuator using such a variable optical rotator. In front and back of the variable optical rotator 85, polarizing elements (rutile single crystals) 86, 88 are arranged in proper orientations to control a polarization state of input light by the variable optical rotator, whereby an optical attenuator is structured in which the attenuation amount is variable. Herein, the crystal-axis orientations of the polarizing elements (rutile single crystals) 86, 88 were determined such that a maximum attenuation amount was obtained when the excitation current supplied to the lamination coil was 0.1A. Due to this, a maximum attenuation amount of −38 dB was obtained at an excitation current of 0.1A while a minimum insertion loss of −0.5 dB was obtained when an excitation current was not flowed. The above variable optical rotator is in a size-reducible structure. Because there are fewer projections in a direction vertical to the light-ray direction, a variable optical attenuator array can be easily structured by a side-by-side arrangement.

FIG. 15 is an explanatory view showing another example of variable optical attenuator. An optical rotator 90 is in a structure not having a permanent magnet so that a magnetic field of a lamination coil 80 only is to be applied. The Faraday element, free of a residual magnetization, in the case that an applied magnetic field intensity is weak, is formed by magnetic domains posing a factor of light scattering. This variable optical attenuator applies this and has a structure combining a lamination coil 80 as magnetic field applying means, a 90-degree Faraday element 81 free of a residual magnetization, and two polarizing elements (rutile single crystals) 86, 88 rendered as crossed-nicol. In the case no current is flowed to the lamination coil 80, the Faraday element 81 is not applied by a magnetic field but formed by magnetic domains. Also, Faraday rotation is not caused. Although the insertion loss resulting from the scatter due to the magnetic domains is nearly −10 dB, the polarizing elements (rutile single crystal plates) 86, 88 are in a crossed-Nicol arrangement and hence a net insertion loss of −40 dB or lower can be obtained. Meanwhile, when an excitation current of 0.1A was flowed to the lamination coil, the insertion loss becomes minimal 0.5 dB.

In the case of arranging optical attenuators of this type side by side into an optical attenuator array, it is possible to utilize an optical rotator array in a structure as shown in FIG. 11.

The present invention, as described above, is an optical rotator arranging a Faraday element in a through-hole of a coil or in the vicinity thereof so that a magnetic field caused by the coil can be applied to the Faraday element, eliminating the necessity of a large-sized yoke as used in the conventional art. Consequently, size and cost reduction is possible and switching time can be shortened. Meanwhile, by arranging a magnetism-holding member on an outer periphery of it, it is possible to increase an applied magnetic field by a coil. The use of a material having a residual magnetization for a Faraday element makes it possible to provide a self-holding function. Accordingly, energy saving is possible by pulse drive.

The present invention, because an optical switch built with an optical rotator as in the above, can be reduced in size and cost and shortened in switch time. Particularly, the structure is suited for integration. Consequently, it is possible to easily obtain a small-sized optical switch array or matrix optical switch.

Furthermore, the present invention, as described above, is a variable optical rotator arranging a Faraday element in a through-hole of a coil so that a magnetic field caused by the coil can be applied to the Faraday element wherein a permanent magnet is arranged. Accordingly, there is no need for a large-sized yoke as used in the conventional art, enabling size and cost reduction. By arranging a magnetism-holding member on an outer periphery of it, it is possible to increase an applied magnetic field by a coil.

The invention, as described above, is an optical switch built with a variable optical rotator as in the above. Accordingly, size and cost reduction is possible, providing a structure suited for integration. Accordingly, it is possible to easily obtain a small-sized variable optical attenuator or variable optical attenuator array.

What is claimed is:

1. An optical rotator comprising: a coil having a through-hole and a Faraday element arranged in the through-hole or a vicinity thereof, whereby a magnetic field caused by the coil is applied to the Faraday element.

2. An optical rotator according to claim 1, wherein the coil is a lamination coil alternately layering electric insulation layers and conductor patterns, the conductor patterns at ends being connected one with another thereby being superposed in a layering direction within an electric insulators in a rectangular frame form.

3. An optical rotator according to claim 1 or 2, wherein a magnetism-holding member of a high magnetic permeable material is arranged at least on a part of an outer periphery of the coil.

4. An optical rotator according to claim 1, wherein the Faraday element is formed of a magnetic garnet crystal having a residual magnetization to have a self-sustaining function.

5. An optical rotator according to claim 1, wherein the Faraday element is formed of a magnetic garnet crystal not having a residual magnetization.

6. An optical rotator array comprising: a lamination coil having a plurality of through-holes and coil parts respectively formed around the through-holes; Faraday elements arranged in the through-holes or a vicinity thereof; and a magnetism-holding member of a high magnetic permeable material arranged at least on a part of an outer periphery of the lamination coil; whereby a magnetic field caused by the coil part is applied to the corresponding Faraday element.

7. An optical switch having an optical rotator, an optical reciprocal rotator, and polarization separating/combining elements respectively arranged on an optical path in front or back thereof, to switch an optical path by switching a coil excitation current, an optical switch wherein the optical rotator comprising: a coil having a through-hole; and a Faraday element arranged in the through-hole or a vicinity thereof; whereby a magnetic field caused by the coil is applied to the Faraday element.

8. An optical switch having an optical rotator, a ½-wavelength plate, and polarizing beam splitters respectively arranged on an optical path in front or back thereof, to switch an optical path by switching a coil excitation current, an optical switch wherein the optical rotator comprising: a coil having a through-hole; and a Faraday element arranged in the through-hole or a vicinity thereof; whereby a magnetic field caused by the coil is applied to the Faraday element.

9. An optical switch having an optical rotator, a ½-wavelength plate, and birefringent elements respectively arranged on an optical path in front or back thereof, to switch an optical path by switching a coil excitation current, an optical switch wherein the optical rotator comprising: a coil having a through-hole; and a Faraday element arranged in the through-hole or a vicinity thereof; whereby a magnetic field caused by the coil is applied to the Faraday element.

10. An optical switch array arranging a plurality of optical switches side by side in a two-dimensional or three-dimensional fashion, the optical switch array wherein
the optical switch is an optical switch comprising: an optical rotator; an optical reciprocal rotator; and polarization separating/combining elements respectively arranged on an optical path in front or back thereof, to switch an optical path by switching a coil excitation current;
the optical rotator comprising: a coil having a through-hole; and a Faraday element arranged in the through-hole or a vicinity thereof; whereby a magnetic field caused by the coil is applied to the Faraday element.

11. A matrix optical switch connecting, in multi stages, optical switches in a lattice form, the matrix optical switch wherein
the optical switch is an optical switch comprising: an optical rotator; a ½-wavelength plate; and polarizing beam splitters respectively arranged on an optical path in front or back thereof, to switch an optical path by switching a coil excitation current;
the optical rotator comprising: a coil having a through-hole; and a Faraday element arranged in the through-hole or a vicinity thereof; whereby a magnetic field caused by the coil is applied to the Faraday element.

12. A variable optical rotator comprising: a coil having a through-hole; a Faraday element arranged in the through-hole or a vicinity thereof; and a permanent magnet arranged close to an outer periphery of the coil, whereby a resultant magnetic field of a variable magnetic field caused by the coil and a fixed magnetic field due to the permanent magnet is applied to the Faraday element.

13. A variable optical rotator according to claim 12, wherein the coil is a lamination coil alternately layering electric insulation layers and conductor patterns, the conductor patterns at ends being connected one with another thereby being superposed in a layering direction within an electric insulators in a rectangular frame form.

14. A variable optical rotator according to claim 12 or 13, wherein a magnetism-holding member of a high magnetic permeable material is arranged at least on a part of an outer periphery of the coil.

15. A variable optical rotator according to claim 12, wherein the Faraday element is formed of a magnetic garnet crystal not having a residual magnetization so that magnetization is saturated by a fixed magnetic field due to the permanent magnet.

16. A variable optical attenuator having a variable optical rotator and polarizing elements arranged on an optical path in front and back thereof, the variable optical attenuator wherein
the variable optical rotator comprising: a coil having a through-hole; a Faraday element arranged in the through-hole or vicinity thereof; and a permanent magnet arranged close to an outer periphery of the coil; whereby a resultant magnetic field of a variable magnetic field caused by the coil and a fixed magnetic field due to the permanent magnet is applied to the Faraday element.

17. A variable optical attenuator having a variable optical rotator and polarizing elements arranged on an optical path in front and back thereof, the variable optical attenuator wherein
the variable optical rotator comprising: a coil having a through-hole; a Faraday element arranged in the through-hole or vicinity thereof; and a permanent magnet arranged close to an outer periphery of the coil; whereby a resultant magnetic field of a variable magnetic field caused by the coil and a fixed magnetic field due to the permanent magnet is applied to the Faraday element;
the Faraday element being a variable optical rotator formed of a magnetic garnet crystal not having a residual magnetization so that magnetization is saturated by a fixed magnetic field due to the permanent magnet.

18. A variable optical attenuator array arranging a plurality of variable optical attenuators side by side, the variable optical attenuator array wherein
the variable optical attenuator having a variable optical rotator and polarizing elements arranged on an optical path in front and back thereof, the variable optical attenuator array wherein
the variable optical rotator comprising: a coil having a through-hole; a Faraday element arranged in the through-hole or vicinity thereof; and a permanent magnet arranged close to an outer periphery of the coil; whereby a resultant magnetic field of a variable magnetic field caused by the coil and a fixed magnetic field due to the permanent magnet is applied to the Faraday element.
